(19) United States
(12) Patent Application Publication
(10) Pub. No.: US 2007/0122711 A1
(43) Pub. Date: May 31, 2007

(54) ELECTRODE AND ELECTROCHEMICAL CELL THEREWITH

(76) Inventors: Naoki TAKAHASHI, Sendai-shi, Miyagi (JP); Tomoki NOBUTA, Sendai-shi, Miyagi (JP); Tetsuya YOSHINARI, Sendai-shi, Miyagi (JP); Takashi MIZUKOSHI, Sendai-shi, Miyagi (JP); Toshihiko NISHIYAMA, Sendai-shi, Miyagi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/563,282

(22) Filed: Nov. 27, 2006

(30) Foreign Application Priority Data
Nov. 29, 2005 (JP) 2005-343760

(51) Int. Cl. H01M 4/62

(52) U.S. Cl. 429/232; 252/182.1

(57) ABSTRACT

An objective of this invention is to provide an electrode and an electrochemical cell which can prevent increase of an electrode resistivity when using a carbon with a larger surface area, prevent deterioration of a high-temperature cycle property caused by increase in the electrode resistivity and have an improved appearance capacity. There are provided an electrode which is a cathode 2 or an anode 3, comprising a proton-conducting compound and two or more carbons as a conduction auxiliary agent, wherein at least one of the carbons is a fibrous carbon, and an electrochemical cell having the electrode.

### BACKGROUND OF THE INVENTION

1. Field of the Invention

The present invention relates to an electrode containing a conduction auxiliary agent and an electrochemical cell therewith such as a secondary battery and an electric double-layer capacitor. In particular, it relates to an electrode having an improved appearance capacity without deterioration of a high-temperature cycle property in an electrochemical cell which has an aqueous electrolyte solution containing a proton source and in which protons act as a charge carrier in a redox reaction in association with charge/discharge, as well as an electrochemical cell therewith.

2. Description of the Prior Art

There have been suggested and practically used electrochemical cells such as secondary batteries and electric double-layer capacitors where a proton-conducting compound is used as an electrode active material.

Such an electrochemical cell has a configuration, for example, as shown in the cross-sectional view of FIG. 1, where a cathode collector 1, on which a cathode 2 containing a proton-conducting compound as an active material is formed, is laminated via a separator 5 with an anode collector 4, on which an anode 3 is formed, and where only protons are involved as a charge carrier. The cell is filled with an aqueous solution containing a proton source as an electrolyte, and sealed by a gasket 6. The cathode 2 and the anode 3 used are generally formed by pressing a mixture containing a doped or undoped powdery proton-conducting compound, a conduction auxiliary agent and a binder. The cathode and the anode thus formed are disposed facing each other via a separator, to form a cell.

The conduction auxiliary agent used may be any conductive carbon such as activated carbon, graphite, fibrous carbon, and carbon black (for example, acetylene black, Ketjen Black and furnace black).

In an electrode used in an electrochemical cell having a cathode containing a proton-conducting compound as an electrode active material, an anode containing a proton-conducting compound as an electrode active material and an aqueous electrolyte solution containing a proton source, it is known that an appearance capacity is improved by using a carbon having a larger surface area as a conduction auxiliary agent. However, due to increase in an electrode resistivity, a fibrous carbon has been exclusively used.

Japanese Patent Application Laid-Open No. 2004-22177 has disclosed a method of mixing and adding a carbon black and a scaly graphite for providing a non-aqueous electrolyte secondary battery exhibiting good high-rate discharge properties. According to the technique, the carbon black which is not homogeneously dispersed alone in an electrode because of its aggregation by absorbing a solvent can be homogeneously dispersed by mixing and adding the scaly graphite which hardly absorbs the solvent, resulting in improved high-rate discharge properties.

However, mixing and adding a carbon black and a scaly graphite is not sufficiently effective for improving properties due to increase in an electrode resistivity when they are covered with an electrode active material.

Alternatively, Japanese Patent Application Laid-Open No. 9-171946 has disclosed a process for manufacturing an electrode of mixing a vapor-grown carbon fiber and a carbon for providing an electric double-layer capacitor having a lower internal resistance.

However, this process is characterized in that the vapor-grown carbon fiber as a conduction auxiliary agent is added to an electric double-layer capacitor containing the carbon material as an active material and is not effective for improving an appearance capacity in an electrochemical cell.

The electrode having a higher resistivity as described above which is used as one electrode, either a cathode or an anode, lead to a considerable difference in a resistivity between the cathode and the anode, resulting in significant deviation of an electrode potential from a proper one. As a result, it may cause a problem that cycle properties are significantly deteriorated, particularly at a high temperature.

In view of the above problems, the present invention relates to an electrode containing two or more carbons as a conduction auxiliary agent and an electrochemical cell having the electrode. An objective of this invention is to provide an electrochemical cell which can prevent increase of an electrode resistivity when using a carbon with a larger surface area, prevent deterioration of a high-temperature cycle property caused by increase in the electrode resistivity and have an improved appearance capacity.

The term, “electrochemical cell” as used herein refers to a secondary battery, an electric double-layer or redox capacitor.

### SUMMARY OF THE INVENTION

To solve the above problems, the present invention provides an electrode which is a cathode or an anode, comprising a proton-conducting compound and two or more carbons as a conduction auxiliary agent, wherein at least one of the carbons is a fibrous carbon.

One embodiment of the present invention is the electrode as described wherein a content of the fibrous carbon is 5 to 70% by weight to the total weight of the carbons as the conduction auxiliary agent.

Further, the present invention provides an electrochemical cell comprising the electrode as described.

One embodiment of the present invention is the electrochemical cell as described wherein the electrode is a cathode.

In accordance with the present invention, an electrode contains two or more carbons as a carbon imparting electric conductivity to the electrode, and at least one of the carbons is fibrous, so that firstly, a particulate or scaly carbon with a large surface area increases a contact area with an active material to improve a reaction efficiency of the active material, resulting in increase in an appearance capacity.

Secondly, the effect described above allows the fibrous carbon to collect electrons transferred to the particulate or scaly carbon with a large surface area, resulting in prevention of increase in an electrode resistivity.

Thirdly, prevention of increase in an electrode resistivity as described above allows an electrode potential during charge/discharge to be maintained properly, resulting in prevention of deterioration of a high-temperature cycle property.

The effects as described above can increase an appearance capacity and provide an electrochemical cell having an excellent high-temperature cycle property in an electrode containing two or more carbons as a conduction auxiliary agent, in which at least one of the carbons is fibrous, and in an electrochemical cell having such an electrode.

### BRIEF DESCRIPTION OF THE DRAWINGS

FIG. 1 is a cross-sectional view of an electrochemical cell in accordance with an embodiment of the present invention and the prior art.

### DETAILED DESCRIPTION OF PREFERRED EMBODIMENTS

An electrode in an electrochemical cell according to the present invention contains, a proton-conducting compound as an active material in electrode materials, a conduction auxiliary agent and a binder, and the conduction auxiliary agent contains two or more carbons. Hereinafter, this invention will be described in the case where the cathode active material is an indole compound (indole trimer) and an anode active material is a quinoxaline compound (polyphenylquinoxaline).

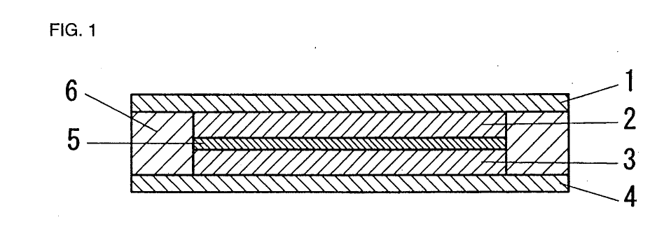

There will be described a process for manufacturing the electrode and the electrochemical cell with reference to the drawing. FIG. 1 is a cross -sectional view of an electrochemical cell according to an embodiment of this invention and the prior art.

The cathode in the electrochemical cell contains two or more carbons as a conduction auxiliary agent where the total weight of the carbons is typically 1 to 50 wt %, preferably 10 to 30 wt % to the total weight of the electrode. Further, the conduction auxiliary agent contains the fibrous carbon in typically 5 to 70 wt %, preferably 10 to 50 wt %, more preferably 15 to 30 wt % to the total weight of the carbons. There is added polyvinylidene fluoride (hereinafter, referred to as “PVDF”) or the like as a binder in typically 1 to 20 wt %, preferably 5 to 10 wt % to the total weight of the electrode. The powdery mixture can be pressed at typically 0 to 300° C., preferably 100 to 250° C., to provide the cathode 2.

The fibrous carbon is preferably that whose aspect ratio is in the range of 3 to 100. Examples of the fibrous carbon include a vapor-grown carbon and a carbon nanotube. The average fiber length of the fibrous carbon is preferably 1 μm or more, more preferably 5 μm or more. When the fiber is too short, the fibrous carbons can't sufficiently come in contact with each other, resulting that the effect of decrease in an electrode resistivity may decrease. The average fiber diameter of the fibrous carbon is preferably 10 to 500 nm, more preferably 50 to 200 nm. When the fiber is too thin, the mechanical strength of the fibrous carbon may decrease. When the fiber is too thick, the mixture with the active material or a non-fibrous carbon can be kept excellent only by using the large amount of the fibrous carbon, possibly resulting in the decrease of the capacity.

Examples of the carbon which is used together with the fibrous carbon include graphites such as natural graphite and artificial graphite, an activated carbon, carbon blacks such as acetylene black and Ketjen Black. The specific surface area of this carbon is preferably 20 m²/g or more, more preferably 50 m²/g or more, further preferably 200 m²/g or more. When the specific surface area is too small, the carbon can't sufficiently come in contact with the active material, resulting that the effect of the capacity improvement may decrease.

In an anode, for example, powdery mixture of polyphenylquinoxaline and Ketjen Black (Ketjen Black International: EC-600JD) as a conduction auxiliary agent at a weight ratio of 72:28 is pressed and fired, to provide the anode 3.

A proton-containing aqueous solution can be used as an electrolyte. A proton content is preferably 10⁻³ mol/l to 18 mol/l, more preferably 10⁻¹ mol/l to 7 mol/l. A content of more than 18 mol/l may make the solution excessively acidic, leading to deterioration of the material activity or dissolution of the material.

A polyolefin porous membrane or a cation-exchange membrane with a thickness of 10 to 50 μm is preferably used as a separator 5.

In the above embodiment, only the cathode contains two or more carbons as a conduction auxiliary agent, but, in the present invention, only the anode may contain the carbons and both of the cathode and the anode may contain the carbons.

The electrochemical cell manufactured using the above electrode has the same configuration as that in a conventional cell. Specifically, a cathode collector 1, on which the cathode 2 containing the proton-conducting compound as the active material is formed, is laminated via the separator 5 with the anode collector 4, on which the anode 3 is formed, and where only protons are involved as a charge carrier. The cell is filled with the aqueous solution containing a proton source as an electrolyte, and sealed by a gasket 6. The cell may have an outer shape such as, but not limited to, a coin and a laminate.

### EXAMPLES

This invention will be more specifically described with reference to Examples.

### Example 1

5-cyanoindole trimer that is a proton-conducting polymer was used as a cathode active material, a vapor-grown carbon (Showa Denko K. K.: VGCF (registered trade mark); hereinafter referred to as “VGCF”) that is a fibrous carbon and Ketjen Black (Ketjen Black International: EC-600JD; hereinafter referred to as “K.B.EC-600JD”) were used as a conduction auxiliary agent, and polyvinylidene fluoride was used as a binder. These are blended with stirring by a blender at weight ratios of active material/carbon/binder=69/23/8 and of VGCF/K.B.EC-600JD=25/75. The mixed powder was pressed at 200° C. to form an electrode which was used as a cathode 2.

In an anode, polyphenylquinoxaline was selected as an anode active material. The active material and K.B.EC-600JD were blended to be a composite at a weight ratio of active material/K.B.EC-600JD=72/28, pressed at 300° C., and fired, which was used as an anode 3. A 20 wt % aqueous sulfuric acid solution was used as an electrolyte. A cation-exchange membrane with a thickness of 15 μm A was used as a separator 5.

The cathode and the anode thus formed was faced each other via the separator, and then they were assembled with a gasket 6, to provide an electrochemical cell.

In terms of the test conditions for the electrochemical cell manufactured, it was charged for 10 min under constant-current (5C) and constant-voltage charge, and discharged under constant-current discharge (1C) until a depth of discharge reached 100%. Under these conditions, an initial capacity determined at 25° C. was defined as an appearance capacity. Under the same charge/discharge conditions, a cycle test was conducted at 60° C.

Table 1 shows a resistivity of the electrode manufactured, and an appearance capacity and a residual capacity ratio after 5,000 cycles at 60° C. of the electrochemical cell manufactured using the electrode.

TABLE 1
Electrode resistivity and electrochemical cell test results

| | | | | High- |
|---|---|---|---|---|
| | | | Improvement ratio | temperature |
| | Electrode | Appearance | in appearance | cycle property |
| | resistivity | capacity | capacity | (% at 5,000 |
| | (Ω · cm) | (mAh/g) | (% vs Comp. Ex. 1) | cycles) |
| Ex. 1 | 4.0 | 82 | 37 | 83 |
| Ex. 2 | 2.5 | 77 | 28 | 88 |
| Ex. 3 | 2.0 | 68 | 13 | 85 |
| Ex. 4 | 4.7 | 80 | 33 | 83 |
| Ex. 5 | 5.8 | 73 | 22 | 81 |
| Ex. 6 | 3.9 | 81 | 35 | 82 |
| Comp. | 1.2 | 60 | — | 85 |
| Ex. 1 | | | | |
| Comp. | 55 | 79 | 34 | 65 |
| Ex. 2 | | | | |

Table 1 shows that an appearance capacity increased by 37% in comparison with Comparative Example 1, and that a high-temperature cycle property was 83% indicating that equivalent properties were maintained.

### Example 2

An electrochemical cell was manufactured as described in Example 1, except that a mixing ratio of VGCF/K.B.EC-600JD was 50/50 by weight. Table 1 shows that an appearance capacity increased by 28% in comparison with Comparative Example 1, and that a high-temperature cycle property was 88%, indicating that equivalent properties were maintained.

### Example 3

An electrochemical cell was manufactured as described in Example 1, except that a mixing ratio of VGCF/K.B.EC-600JD was 75/25 by weight. Table 1 shows that an appearance capacity increased by 13% in comparison with Comparative Example 1, and that a high-temperature cycle property was 85%, indicating that equivalent properties were maintained.

### Example 4

An electrochemical cell was manufactured as described in Example 1, except that VGCF and an activated carbon were used as a conduction auxiliary agent and these are blended at a weight ratio of VGCF/activated carbon=25/75. Table 1 shows that an appearance capacity increased by 33% in comparison with Comparative Example 1, and that a high-temperature cycle property was 83%, indicating that equivalent properties were maintained.

### Example 5

An electrochemical cell was manufactured as described in Example 1, except that VGCF and an acetylene black were used as a conduction auxiliary agent and these are blended at a weight ratio of VGCF/acetylene black=25/75. Table 1 shows that an appearance capacity increased by 21% in comparison with Comparative Example 1, and that a high-temperature cycle property was 81%, indicating that equivalent properties were maintained.

### Example 6

An electrochemical cell was manufactured as described in Example 1, except that VGCF, Ketjen Black and an activated carbon were used as a conduction auxiliary agent and these are blended at a weight ratio of VGCF/Ketjen Black/activated carbon=25/50/25. Table 1 shows that an appearance capacity increased by 35% in comparison with Comparative Example 1, and that a high-temperature cycle property was 82%, indicating that equivalent properties were maintained.

### Comparative Example 1

An electrochemical cell was manufactured as described in Example 1, except that VGCF was used as a conduction auxiliary agent.

### Comparative Example 2>

An electrochemical cell was manufactured as described in Example 1, except that K.B.EC-600JD was used as a conduction auxiliary agent.

Table 1 shows resistivities of the electrodes manufactured, and appearance capacities and residual capacity ratios after 5,000 cycles at 60° C. of the electrochemical cells manufactured using these electrodes. It can be seen that the use of an electrode according to the present invention increased an appearance capacity by 13 to 37% in comparison with Comparative Example 1. It can be furthermore seen that a high-temperature cycle property was maintained as equivalent as that in Comparative Example 1, and that deterioration in a high-temperature cycle property experienced in Comparative Example 2 using only a high surface-area carbon was prevented.

As described above, in an electrode according to the present invention and an electrochemical cell manufactured using the electrode, an appearance capacity can be increased without deterioration of a high-temperature cycle property. It is because; firstly, a particulate or scaly carbon with a large surface area increases a contact area with an active material to improve a reaction efficiency of the active material, resulting in increase in an appearance capacity; secondly, the fibrous carbon can collect electrons transferred to the particulate or scaly carbon with a large surface area, resulting in prevention of increase in an electrode resistivity; and resultantly, an electrode potential during charge/discharge can be maintained properly, resulting in prevention of deterioration of a high-temperature cycle property.

What is claimed is:

1. An electrode which is a cathode or an anode, comprising a proton-conducting compound and two or more carbons as a conduction auxiliary agent, wherein at least one of the carbons is a fibrous carbon.

2. The electrode as claimed in claim 1, wherein a content of the fibrous carbon is 5 to 70% by weight to the total weight of the carbons as the conduction auxiliary agent.

3. An electrochemical cell, comprising the electrode as claimed in claim 1.

4. The electrochemical cell as claimed in claim 3, wherein the electrode is a cathode.

5. An electrochemical cell, comprising the electrode as claimed in claim 2.

6. The electrochemical cell as claimed in claim 5, wherein the electrode is a cathode.
